(19) United States
(12) Patent Application Publication
(10) Pub. No.: US 2024/0330833 A1
(43) Pub. Date: Oct. 3, 2024

(54) CAST PRODUCT MANAGEMENT SYSTEM

(71) Applicant: SINTOKOGIO, LTD., Nagoya-shi (JP)

(72) Inventors: Takashi HANAI, Nagoya-shi (JP); Takehiro Sugino, Nagoya-shi (JP)

(73) Assignee: SINTOKOGIO, LTD., Nagoya-shi (JP)

(21) Appl. No.: 18/595,712

(22) Filed: Mar. 5, 2024

(30) Foreign Application Priority Data
Mar. 31, 2023 (JP) 2023-057636

(51) Int. Cl. G06Q 10/0639; G06Q 10/087; G06Q 50/04

(52) U.S. Cl. CPC G06Q 10/06395; G06Q 10/087; G06Q 50/04

(57) ABSTRACT

A cast product management system includes: an acquisition unit configured to acquire, from an input terminal, information on a defect of an inspected cast product; a database configured to the information on the defect acquired by the acquisition unit and information on a period when the cast product is manufactured in association with each other; and an output unit configured to output a time-series transition of the information on the defect with reference to the database.

### CROSS-REFERENCE TO RELATED APPLICATION

This application is based on Japanese Application No. 2023-057636 filed with Japan Patent Office on Mar. 31, 2023, the entire contents of which are hereby incorporated by reference.

### TECHNICAL FIELD

The present disclosure relates to a cast product management system.

### BACKGROUND

Japanese Unexamined Patent Publication No. H7-32131 discloses a device for inferring the cause and countermeasure of a casting deficiency. This device uses a computer to infer a cause and a countermeasure for at least one of a hole or a crack generated in a cast product or the surface thereof, a defect in a surface state, and a deficiency such as a dimension or shape defect without using casting conditions.

### SUMMARY

The device described in Japanese Unexamined Patent Publication No. H7-32131 can provide a countermeasure from a situation when the defect occurs, but there is room for improvement in order to provide a more effective countermeasure. The present disclosure provides a technique capable of outputting information that can be used to determine a countermeasure against the defect of a cast product.

A cast product management system includes: an acquisition unit configured to acquire, from an input terminal, information on a defect of an inspected cast product; a database configured to the information on the defect acquired by the acquisition unit and information on a period when the cast product is manufactured in association with each other; and an output unit configured to output a time-series transition of the information on the defect with reference to the database.

The present disclosure can output information that can be used to determine a countermeasure against the defect of a cast product.

### BRIEF DESCRIPTION OF THE DRAWINGS

FIG. 1 is a block diagram illustrating an example of the configuration of a cast product management system;

FIG. 2 is a diagram illustrating an example of a screen output to an input terminal;

FIG. 3 is an image output to a display terminal according to one exemplary embodiment;

FIG. 4 is an image output to a display terminal according to another exemplary embodiment; and

FIG. 5 is an image output to a display terminal according to still another exemplary embodiment.

### DETAILED DESCRIPTION

### Exemplary Embodiments of Present Disclosure

Hereinafter, embodiments of the present disclosure will be described in detail with reference to the drawings. In the description of the drawings, the same elements are denoted by the same reference numerals, and redundant description is omitted.

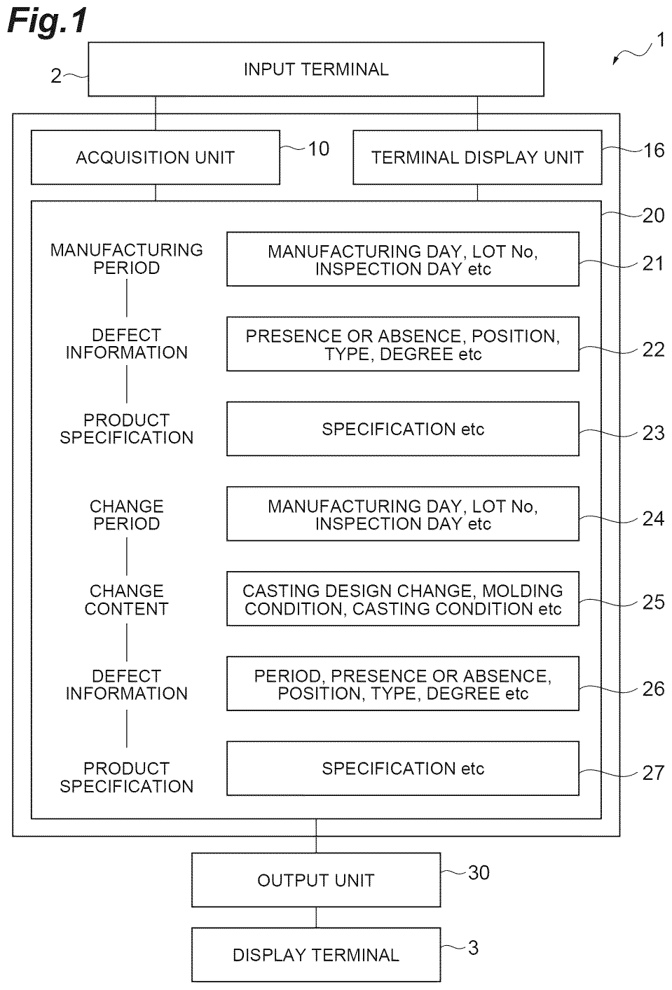

FIG. 1 is a block diagram illustrating an example of the configuration of a cast product management system. A cast product management system 1 illustrated in FIG. 1 is a management system that manages the inspection result of a cast product. In the management system, a worker who performs inspection inputs data, and an administrator of the system utilizes the input data. The cast product management system 1 includes an acquisition unit 10, a database 20, and an output unit 30. In one example, the cast product management system 1 includes a terminal display unit 16. The cast product management system 1 is configured as a general computer system or a programmable logic controller (PLC) including a central processing unit (CPU), a main storage device (an example of a storage medium) such as a random access memory (RAM) and a read only memory (ROM), an auxiliary storage device (an example of a storage medium) such as a hard disk, and the like.

The acquisition unit 10 acquires, from an input terminal 2, information on the defect of an inspected cast product. The input terminal 2 includes, for example, an input device such as a touch panel or a keyboard. The input terminal 2 may be another computer system connected to the cast product management system 1, a tablet terminal, or a cast product inspection system. In the present embodiment, the acquisition unit 10 acquires the information on the defect of the cast product and information on a period when the cast product is manufactured in association with each other. The acquisition unit 10 may acquire information on a specification of the cast product and information on a worker.

In the present embodiment, the information on the defect of the cast product includes information on the type of the defect and information on the position of the defect. In one example, the information on the type of the defect includes at least one information of defects such as sand inclusion, mold drop, mold shift, chip, push up, misrun, dent, crack, shrinkage, blow hole, cold shut, shot, slag, scab, broken casting at gate, burn on, finishing, and core defect. The information on the type of the defect may include information on an organization in which the defect has occurred, such as an external process, an internal process, and a specific internal process.

The information on the position of the defect includes information indicating the position of the defect in the cast product. In one example, the acquisition unit 10 acquires the position of the defect corresponding to the appearance of the cast product. The information on the defect of the cast product may further include one of information indicating that the cast product does not include a defect, information indicating that the cast product includes a defect capable of being repaired, and information indicating that the cast product includes a defect incapable of being repaired. The information indicating that the cast product does not include a defect may mean that the information on the defect of the cast product is not included.

In one example, the information on the period when the cast product is manufactured includes at least one information of a time when the cast product is manufactured, the lot number of the cast product, and a time when the cast product is inspected. For example, in a case where the manufacture of the cast product, the inspection of the cast product, and the acquisition of the information on the defect are continuously executed, the time when the cast product is manufactured is estimated from the lot number of the cast product or the time when the cast product is inspected, and thus, the lot number of the cast product and the time when the cast product is inspected can be stored as the information on the period when the cast product is manufactured.

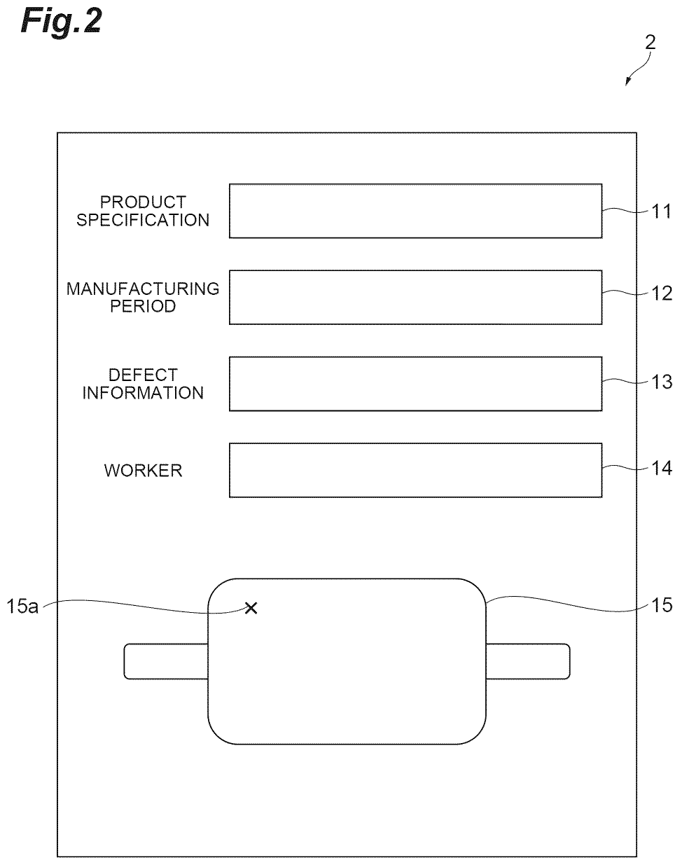

FIG. 2 is a diagram illustrating an example of a screen output to an input terminal. In one example, the input terminal 2 displays a product specification input field 11, a manufacturing period input field 12, a defect information input field 13, and a worker name input field 14. The specification of the cast product is input to the input field 11. In one example, the specification of the cast product includes the model number of the cast product. Information on the manufacturing period of the cast product is input to the input field 12. The information on the defect of the cast product is input to the input field 13. In the worker name input field 14, the name of the worker who has inspected the cast product is input. Corresponding information may be automatically input to each of the input fields 11 to 14. A list of the defect types described above may be displayed in the input field 13. The worker may input information on the defect type by selecting at least one from the list of the defect types displayed in the input field 13. In the product specification input field 11 and/or the manufacturing period input field 12, a value read from an identifier given to the cast product may be input. The identifier includes, for example, a two-dimensional code, a character, or a symbol or the like. The identifier may be directly given to the cast product by engraving or casting, or may be indirectly given to the cast product by a slip attached to the cast product or a conveyance tool of the cast product.

In the present embodiment, the appearance 15 of the cast product is further displayed on the input terminal 2. The appearance 15 of the cast product is, for example, the appearance of the cast product corresponding to the product specification input in the product specification input field 11. The appearance 15 of the cast product is displayed on the basis of the information on the appearance of the cast product output from the terminal display unit 16 to the input terminal 2. The information on the appearance 15 of the cast product includes, for example, a photograph of the cast product, or a figure or an image obtained from the two-dimensional model or three-dimensional model of the cast product. The worker inputs the position 15a of the defect in the appearance 15 of the cast product by pointing to the appearance 15 of the cast product displayed on the input terminal 2. A plurality of positions 15a of the defects may be designated. The acquisition unit 10 acquires the position 15a of the defect designated on the appearance 15 of the cast product output to the input terminal 2 as the information on the position of the defect. The information on the appearance of the cast product may be stored in the database 20. In this case, the terminal display unit 16 outputs the information on the appearance of the cast product to the input terminal 2 with reference to the database 20.

The database 20 stores information 21 on the period when the cast product is manufactured and information 22 on the defect acquired by the acquisition unit 10 in association with each other. In the present embodiment, the database 20 stores the information 21 on the period, the information 22 on the defect, and the information 23 on the specification of the cast product in association with each other.

The database 20 may store information 24 on a period when the manufacturing process of the cast product is changed and information 25 on the content of the change in the manufacturing process in association with each other. In one example, the information 24 on the period when the manufacturing process is changed includes at least one of the time when the manufacturing process is changed and the lot number of the cast product manufactured after the manufacturing process is changed. The information 25 on the content of the change in the manufacturing process includes at least one information of a casting design change, a molding condition, and a casting condition and the like. The molding condition includes, for example, information on the amount of moisture, new sand, fine powder, or bentonite contained in casting sand, or information on a squeezing pressure or a mold thickness. The casting condition includes, for example, information on an inoculant amount, a pouring rate, or the temperature of molten metal to be poured. The information on the content of the change in the manufacturing process may include information on maintenance and adjustment of a molding machine or a molding line.

In the present embodiment, the manufacturing process is changed by a countermeasure against the defect of the cast product. The countermeasure is a change in a manufacturing process which is carried out for at least one defect. The countermeasure includes intended to solve the defect. When the content of the change in the manufacturing process is the countermeasure against the defect, the database 20 stores information 25 on the change in the manufacturing process and information 26 on the defect in association with each other. The information 26 on the defect may include information 22 on the defect of the cast product and information 21 on the period when the cast product is manufactured. In the present embodiment, the database 20 stores the information 24 on the period when the manufacturing process of the cast product is changed, the information 25 on the content of the change in the manufacturing process, the information 26 on the defect, and information 27 on the specification of the cast product in association with each other. As described above, the information 26 on the defect may include information on the position of the defect.

The output unit 30 outputs information 31 including the time-series transition of the information on the defect with reference to the database 20. The time-series transition of the information on the defect includes information indicating the temporal variation of the information on the defect. The time-series transition of the information on the defect includes, for example, information on the defect presented or displayed in time order based on the information 21 on the period when the cast product is manufactured. In the present embodiment, the output unit 30 outputs information 31 including the time-series transition to the display terminal 3. In one example, the output unit 30 outputs an image visually indicating the transition of the defect of the cast product according to the period when the cast product is manufactured as the information 31 including the time-series transition. The image includes non-verbal information. The image includes at least one of a still image and a moving image. The display terminal 3 includes, for example, a display device such as a display. The display terminal 3 may include another computer system connected to the cast product management system 1 or a tablet terminal.

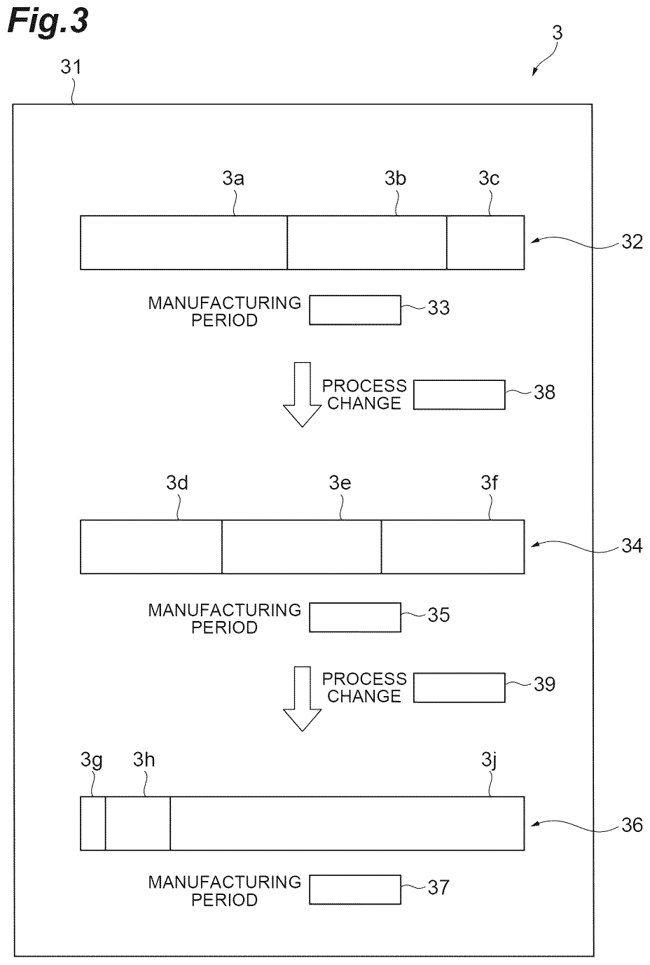

FIG. 3 is an image output to a display terminal according to one exemplary embodiment. In the example of FIG. 3, in the display terminal 3, as the information 31 including the time-series transition, graphs 32, 34, and 36 illustrating the transitions of the respective proportions of a cast product not including a defect, a cast product including a defect capable of being repaired, and a cast product including a defect incapable of being repaired are illustrated.

Hereinafter, the cast product not including a defect may be referred to as a “non-defective product”, the cast product including a defect capable of being repaired may be referred to as a “correctable product”, and the cast product including a defect incapable of being repaired may be referred to as a “defective product”. The information 31 including the time-series transition displayed on the display terminal 3 is not limited to the graph. As the information 31 including the time-series transition, plots indicating the transitions of the quantities of the non-defective product, the correctable product, and the defective product in a predetermined period may be indicated.

The graph 32 indicates the proportions of the defective product 3a, the correctable product 3b, and the non-defective product 3c in a first period. In the present embodiment, a manufacturing period 33 indicating the first period is shown together with the graph 32. The graph 34 indicates the proportions of the defective product 3d, the correctable product 3e, and the non-defective product 3f in a second period. The second period is a period after the first period. In the present embodiment, a manufacturing period 35 indicating the second period is shown together with the graph 34. The graph 36 indicates the proportions of the defective product 3g, the correctable product 3h, and the non-defective product 3j in a third period. The third period is a period after the second period. In the present embodiment, a manufacturing period 37 indicating the third period is shown together with the graph 36. In the present embodiment, the graphs 32, 34, and 36 are bar graphs indicating the proportions of the non-defective product, the correctable product, and the defective product in the periods in percentages. Each of the graphs 32, 34, and 36 may be a circular graph or the like.

The output unit 30 may output the information 24 on the period when the manufacturing process of the cast product is changed and the information 25 on the content of the change in the manufacturing process together with the time-series transition of the information on the defect with reference to the database 20.

In the present embodiment, a first change in the manufacturing process of the cast product was performed between the first period and the second period. The first period and the second period are periods before and after the first change. In one example, a first process change 38 in which information on the period of the first change and information on the content of the first change are associated with each other is illustrated between the graph 32 and the graph 34.

In the present embodiment, the first change is a countermeasure against a first defect. The output unit 30 outputs information on transition in which the information on the content of the first change and the information on the first defect are associated with each other with reference to the database 20. The information on the first defect may include information on the period when the cast product including the first defect is manufactured.

In the present embodiment, a second change in the manufacturing process of the cast product was performed between the second period and the third period. The second period and the third period are periods before and after the second change. In one example, a second process change 39 in which information on the period of the second change and information on the content of the second change are associated with each other is illustrated between the graph 34 and the graph 36.

In the present embodiment, the second change is a countermeasure against a second defect. The output unit 30 outputs information on transition in which the information on the content of the second change and the information on the second defect are associated with each other with reference to the database 20. The information on the second defect may include information on the period when the cast product including the second defect is manufactured.

According to the graphs 32 and 34 and the first process change 38, the transition is illustrated, in which the proportion of the defective product decreases from the defective product 3a to the defective product 3d and the proportion of the non-defective product increases from the non-defective product 3c to the non-defective product 3f by the first process change 38 is illustrated. According to the graphs 34 and 36 and the second process change 39, a transition is illustrated, in which the proportion of the defective product decreases from the defective product 3d to the defective product 3g, the proportion of the correctable product decreases from the correctable product 3e to the correctable product 3h, and the proportion of the non-defective product increases from the non-defective product 3f to the non-defective product 3j by the second process change 39. In this case, the administrator can intuitively understand the change in the defect the after the countermeasure.

The specification of the cast product may be displayed together with each of the graphs 32, 34, and 36. Each of the graphs 32, 34, and 36 may be a graph showing the transition of the proportion of a defective product, a correctable product, and a non-defective product in a cast product having a predetermined specification. Each of the graphs 32, 34, and 36 may be a graph showing the transition of the proportion of a defective product, a correctable product, and a non-defective product in cast products of all specifications.

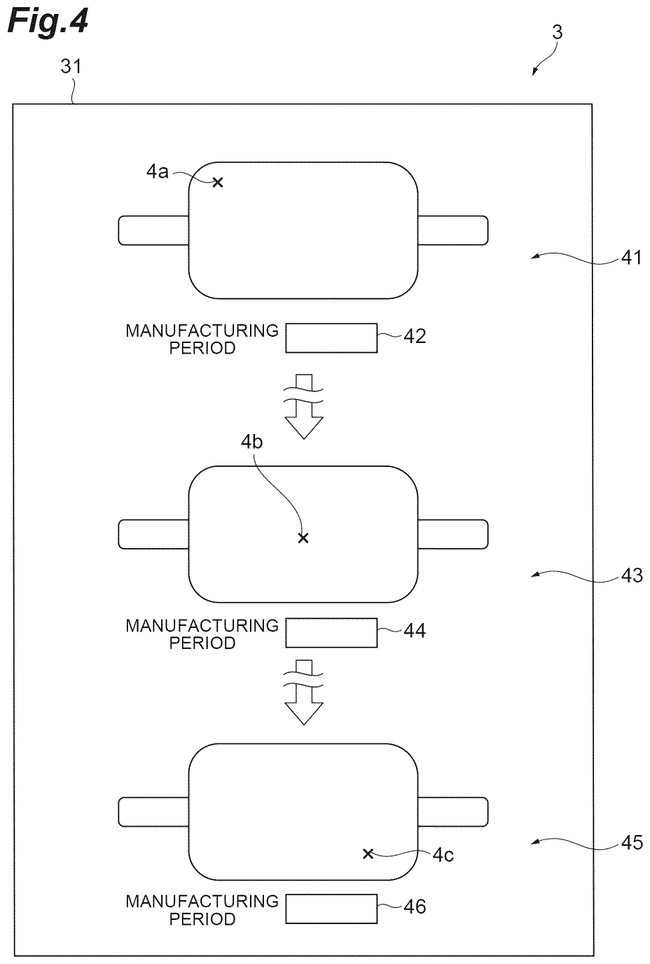

The output unit 30 may output an image including the appearance of the cast product and the position of the defect as information 31 including the time-series transition. FIG. 4 is an image output to a display terminal according to another exemplary embodiment. In the example of FIG. 4, the display terminal 3 displays a plurality of still images arranged in order based on the information on the period when the cast product is manufactured. Each still image shows the position of the defect. Each still image includes, for example, a photograph of the cast product, or a figure or image obtained from the two-dimensional model or three-dimensional model of the cast product. Each still image may include the appearance 15 of the cast product output from the terminal display unit 16 to the input terminal 2 and the position 15a of the defect in the appearance 15 of the cast product input by the worker.

The cast product 41 illustrated in the display terminal 3 of FIG. 4 is a still image of one cast product among the plurality of cast products manufactured in the first period. In FIG. 4, an image of another plurality of cast products manufactured in the first period is not illustrated. The cast product 41 indicates the appearance of the cast product manufactured in the first period and the position 4a of the defect in the appearance of the cast product. In the present embodiment, a manufacturing period 42 of the cast product 41 is shown together with the cast product 41.

A cast product 43 illustrated in the display terminal 3 of FIG. 4 is a still image of one cast product among the plurality of cast products manufactured in the second period. In FIG. 4, an image of another plurality of cast products manufactured in the second period is not illustrated. The cast product 43 indicates the appearance of the cast product manufactured in the second period and the position 4b of the defect in the appearance of the cast product. In the present embodiment, a manufacturing period 44 of the cast product 43 is shown together with the cast product 43.

A cast product 45 illustrated in the display terminal 3 of FIG. 4 is a still image of one cast product among the plurality of cast products manufactured in the third period. In FIG. 4, an image of another plurality of cast products manufactured in the third period is not illustrated. The cast product 45 indicates the appearance of the cast product manufactured in the third period and the position 4c of the defect in the appearance of the cast product. In the present embodiment, a manufacturing period 46 of the cast product 45 is shown together with the cast product 45.

The display terminal 3 displays a plurality of still images 41n of a plurality of cast products manufactured in the first period including the cast product 41, a plurality of still images 43n of a plurality of cast products manufactured in the second period including the cast product 43, and a plurality of still images 45n of a plurality of cast products manufactured in the third period including the cast product 45. In each of the plurality of still images 41n, 43n, and 45n, the position of the defect in the appearance of each cast product and the manufacturing period of each cast product are shown. Therefore, according to the plurality of still images shown in the display terminal 3, the transition of the position of the defect moving according to the period when each cast product is manufactured is shown.

The output unit 30 may output the information 24 on the period when the manufacturing process of the cast product is changed, the information 25 on the content of the change in the manufacturing process, and the information 27 on the specification of the cast product together with the time-series transition of the information on the defect with reference to the database 20. In one example, along with each of the plurality of still images 41n, 43n, and 45n, the information 24 on the period when the manufacturing process of the cast product is changed, the information 25 on the content of the change in the manufacturing process, and the information 27 on the specification of the cast product are indicated by the output unit 30. For example, information indicating a cast product manufactured after the first process change 38 may be displayed together with the plurality of still images 43n by the output unit 30. Information indicating a cast product manufactured after the second process change 39 may be displayed together with the plurality of still images 45n by the output unit 30.

The output unit 30 may output the time-series transition of the information on the defect for each product with reference to the database 20. The output unit 30 may output information on transition sorted by the information on the position of the defect. For example, when the position of the first defect in the cast product is similar to the position of the second defect in another cast product, the output unit 30 outputs the transitions of the first defect and the second defect by the first defect and a first countermeasure, and the second defect and a second countermeasure to the display terminal 3. In one example, when the first defect and the second defect are cold shut, the first defect and the second defect occur at similar positions where the molten metal joins. Therefore, the administrator can efficiently take the countermeasure against the defect with reference to the information on the transition sorted by the information on the position of the defect.

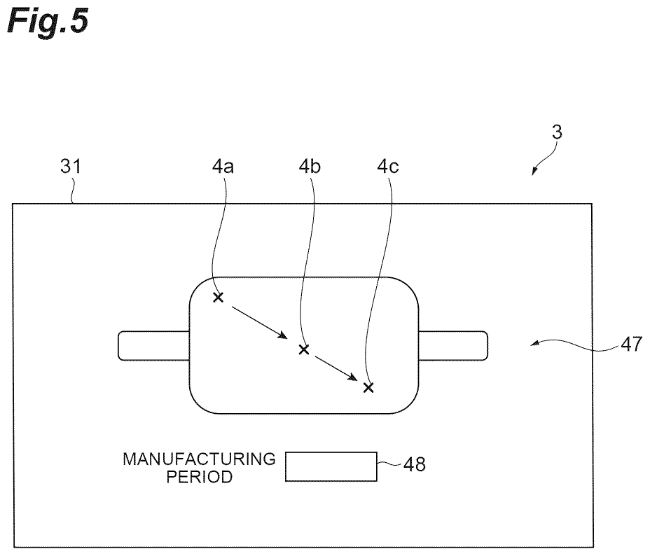

FIG. 5 is an image output to a display terminal according to still another exemplary embodiment. In the example of FIG. 5, a plurality of still images 47 are continuously displayed on the display terminal 3 as if to turn over the pages in order based on the information on the period when the cast product is manufactured. In this case, the positions of the plurality of defects corresponding to the plurality of still images 47 are displayed to move on the cast product. In the example of FIG. 5, the position of the defect is shown to move from the position 4a of the defect of the plurality of cast products manufactured in the first period to the position 4b of the defect of the plurality of cast products manufactured in the second period and the position 4c of the defect of the plurality of cast products manufactured in the third period.

Although various exemplary embodiments have been described above, the present disclosure is not limited to the above embodiments, and various omissions, substitutions, and changes may be made.

The acquisition unit 10 may not acquire the information on the period when the cast product is manufactured. In this case, the database 20 stores the time stored in the database 20 as the information on the period when the cast product is manufactured. For example, in a case where the manufacturing of the cast product, the inspection of the cast product, the acquisition of the information on the defect, and the storage of the information on the defect are continuously executed, the time when the cast product is manufactured is estimated from the time when the information on the defect is stored in the database 20, and thus the time stored in the database 20 can be stored as the information on the period when the cast product is manufactured.

The information on the position of the defect in the appearance of the cast product output by the output unit 30 may be a moving image. The image indicating the information on the appearance of the cast product and the information on the position of the defect output by the output unit 30 may be a contour diagram. The cast product management system may be used as a mold management system.

The time-series transition of the information on the defect output by the output unit 30 may be one in which the information on the defect is arranged on the basis of the defect discovery date and time. The output unit 30 may determine whether a defect similar to the similar position or another defect occurs for each product. The output unit 30 may display the past defect countermeasure outline and the result thereof with reference to the database 20. The function of the cast product management system 1 may be provided by a program or a recording medium recording the program.

### [Modes Included in Present Disclosure]

The present disclosure includes the following modes.

(Clause 1) A cast product management system including: an acquisition unit configured to acquire, from an input terminal, information on a defect of an inspected cast product; a database configured to the information on the defect acquired by the acquisition unit and information on a period when the cast product is manufactured in association with each other; and an output unit configured to output a time-series transition of the information on the defect with reference to the database.

In the cast product management system according to Clause 1, the information on the defect of the cast product and the information on the period when the cast product is manufactured are stored in the database in association with each other. The output unit outputs the time-series transition of the information on the defect with reference to the database. Since the time-series transition of the information on the defect includes the occurrence situation and the tendency of the defect, it can be used to determine the priority order of the defect countermeasure. Therefore, the management system can output information that can be used to determine the countermeasure against the defect of the cast product.

(Clause 2) In the cast product management system according to Clause 1, the information on the defect may include information on a position of the defect in the cast product. The cast product management system according to Clause 2 can output information capable of confirming a change in the position of the defect of the cast product.

(Clause 3) The cast product management system according to Clause 2 may further include a terminal display unit configured to cause the input terminal to display an appearance of the cast product, wherein the acquisition unit may acquire a position of the defect designated on the cast product displayed on the input terminal as the information on the position of the defect.

The cast product management system according to Clause 3 enables a worker to intuitively input the position of the defect of the cast product.

(Clause 4) In the cast product management system according to Clause 2 or 3, the output unit may be configured to output an image including an appearance of the cast product and the position of the defect. The cast product management system according to Clause 4 can output information capable of visually confirming a change in the position of the defect of the cast product.

(Clause 5) In the cast product management system according to Clause 4, the image may include a plurality of still images displayed in order based on the information on the period when the cast product is manufactured. The cast product management system according to Clause 5 can output information capable of intuitively grasping a change in the position of the defect of the cast product.

(Clause 6) In the cast product management system according to any one of Clauses 2 to 5, the database may store information on a period when a manufacturing process of the cast product is changed, information on a content of the change in the manufacturing process, information on a specification of the cast product, and the information on the position of the defect in association with each other, and the output unit may output, with reference to the database, the information on the period when the manufacturing process of the cast product is changed, the information on the content of the change in the manufacturing process, and the information on the specification of the cast product together with a time-series transition of the position of the defect. The cast product management system according to Clause 6 can output information capable of confirming a change in the position of the defect of a cast product according to a change in a manufacturing process in the cast product having a predetermined specification.

(Clause 7) In the cast product management system according to any one of Clauses 1 to 6, the database may store information on a period when the manufacturing process of the cast product is changed, information on a content of the change in the manufacturing process, and information on the defect in association with each other, and the output unit may output, with reference to the database, the information on the period when the manufacturing process of the cast product is changed and the information on the content of the change in the manufacturing process together with a time-series transition of the information on the defect. The cast product management system according to Clause 7 can output information capable of confirming a change in the defect of the cast product according to the change in the manufacturing process.

(Clause 8) In the cast product management system according to Clause 6 or 7, the manufacturing process may be changed by a countermeasure against the defect. The cast product management system according to Clause 8 can output information capable of confirming a change in the defect of the cast product before and after the countermeasure.

(Clause 9) In the cast product management system according to any one of Clauses 1 to 8, the information on the defect may include one of information indicating that the cast product does not include a defect, information indicating that the cast product includes a defect capable of being repaired, and information indicating that the cast product includes a defect incapable of being repaired. The cast product management system according to Clause 9 can output information capable of confirming a quantitative change in each of a cast product including no defect, a cast product including a defect capable of being repaired, and a cast product including a defect incapable of being repaired.

(Clause 10) In the cast product management system according to any one of Clauses 1 to 9, the database may store the information on the defect acquired by the acquisition unit, the information on the period when the cast product is manufactured, and the information on the specification of the cast product in association with each other, and the output unit may output, with reference to the database, information on a specification of the cast product together with the time-series transition of the information on the defect. The cast product management system according to Clause 10 can output information capable of confirming a change in the defect of a cast product according to a change in a manufacturing process in the cast product having a predetermined specification.

What is claimed is:

1. A cast product management system comprising:
an acquisition unit configured to acquire, from an input terminal, information on a defect of an inspected cast product;
a database configured to store the information on the defect acquired by the acquisition unit and information on a period when the cast product is manufactured in association with each other; and
an output unit configured to output a time-series transition of the information on the defect with reference to the database.

2. The cast product management system according to claim 1,
wherein the information on the defect includes information on a position of the defect in the cast product.

3. The cast product management system according to claim 2, further comprising
a terminal display unit configured to cause the input terminal to display an appearance of the cast product,
wherein the acquisition unit acquires a position of the defect designated on the cast product displayed on the input terminal as the information on the position of the defect.

4. The cast product management system according to claim 2,
wherein the output unit is configured to output an image including an appearance of the cast product and the position of the defect.

5. The cast product management system according to claim 4,
wherein the image includes a plurality of still images displayed in order based on the information on the period when the cast product is manufactured.

6. The cast product management system according to claim 2,
wherein the database stores information on a period when a manufacturing process of the cast product is changed, information on a content of the change in the manufacturing process, information on a specification of the cast product, and the information on the position of the defect in association with each other, and
the output unit outputs, with reference to the database, the information on the period when the manufacturing process of the cast product is changed, the information on the content of the change in the manufacturing process, and the information on the specification of the cast product together with a time-series transition of the position of the defect.

7. The cast product management system according to claim 1,
wherein the database stores information on a period when the manufacturing process of the cast product is changed, information on a content of the change in the manufacturing process, and information on the defect in association with each other, and
the output unit outputs, with reference to the database, the information on the period when the manufacturing process of the cast product is changed and the information on the content of the change in the manufacturing process together with a time-series transition of the information on the defect.

8. The cast product management system according to claim 6,
wherein the manufacturing process is changed by a countermeasure against the defect of the cast product.

9. The cast product management system according to claim 1,
wherein the information on the defect includes one of information indicating that the cast product does not include a defect, information indicating that the cast product includes a defect capable of being repaired, and information indicating that the cast product includes a defect incapable of being repaired.

10. The cast product management system according to claim 9,
wherein the database stores the information on the defect acquired by the acquisition unit, the information on the period when the cast product is manufactured, and the information on the specification of the cast product in association with each other, and
the output unit outputs, with reference to the database, information on a specification of the cast product together with the time-series transition of the information on the defect.
